(19) United States
(12) Patent Application Publication
(10) Pub. No.: US 2017/0150734 A1
(43) Pub. Date: Jun. 1, 2017

(54) FOOD COMPRISING PROTEINS MAINLY OF PLANT ORIGIN AND PREPARATION METHOD THEREOF

(71) Applicant: ONYX DEVELOPPEMENT SAS, Malaunay (FR)

(72) Inventors: Jean Paul LORAND, MALAUNAY (FR); Lamisse KANDIL, MALAUNAY (FR); Jean Baptiste D'HUART, MALAUNAY (FR)

(21) Appl. No.: 15/300,185

(22) PCT Filed: Mar. 27, 2015
(86) PCT No.: PCT/FR2015/050795

§ 371 Date: Sep. 28, 2016

(30) Foreign Application Priority Data
Mar. 28, 2014 (FR) 14 00765

(51) Int. Cl. A23C 20/02; A23L 33/185; A23J 3/34; A23J 3/14; A23J 3/16

(52) U.S. Cl. CPC A23C 20/025; A23J 3/14; A23J 3/16; A23J 3/346; A23L 33/185; A23V 2002/00

(57) ABSTRACT

A food including proteins mainly of plant origin obtainable by a method including the steps consisting of:
(i) selecting a natural source of plant proteins including nutrients;
(ii) extracting vegetable juice from the natural source of plant proteins, the vegetable juice including almost all or all of the nutrients contained in the natural source of plant proteins; and
(iii) treating the vegetable juice from step (ii) with transglutaminase,
   characterized in that the food also includes a food ingredient of non-animal origin when the natural source of plant proteins is made exclusively of soya.

The present invention relates to food comprising proteins mainly of plant origin as well as to a method of producing said food.

Proteins, along with carbohydrates and lipids, are one of the three major families of macronutrients that contribute to energy intake.

Essential to the body, proteins play a structural role (at the muscle or cutaneous level) but are also involved in many processes such as immune response (antibodies), transporting oxygen in the body (hemoglobin) or digestion (digestive enzymes).

Two major classes of proteins exist, animal proteins and plant proteins.

Animal proteins mainly come from milk, eggs, fish and meat.

Plant proteins mainly come from cereal grains and leguminous plants.

It has been established that over 70% of the protein consumed in western societies is of animal origin, versus only 15-20% in developing countries.

This difference between industrialized and developing countries is explained, in particular, by the fact that the production of animal proteins is more expensive than the production of plant proteins.

In addition, animal raw materials such as milk, fish or meat are much more difficult to preserve than plant raw materials.

In addition, the negative environmental impacts of meat production, both intensive and extensive, are increasingly emphasized. It mainly results in a risk of deteriorating water quality, substituting forests with grassland, reducing biodiversity or producing greenhouse gases.

Lastly, the availability of animal products will decrease over the next 50 years.

It would be desirable to find an alternative to food products based on animal proteins such as, for example, cheeses or milk-based desserts.

However, the main difficulty in this alternative resides in the presence of antinutritional factors such as phytic acid and the flatulence factor and antitrypsin factor present in plant proteins. Moreover, plant proteins, unlike animal proteins, once mixed with other ingredients, are difficult to shape due to the fact that plant proteins have less functionality compared to animal proteins that are structured by nature.

Forms for structuring plant protein-based products exist but they are undeveloped and their market supply is limited in developing countries.

Transglutaminase, often called “meat glue,” is an enzyme that is widely used in the food industry. This enzyme is composed of chains of amino acids and acts on the proteins in food products to bind them together.

Transglutaminase also improves the texture of protein-rich products. For example, it has been demonstrated that transglutaminase improves the texture of tofu (Liu, Chang & Tatsumi. 2004. Effect of thermal pretreatment of raw soymilk on the gel strength and microstructure of tofu induced by microbial transglutaminase. China: Department of food science and technology, 7p).

In this document, soy milk is extracted and then transformed into tofu. During this transformation into tofu, the nutrient-rich serum is eliminated by draining. The tofu thus obtained contains very low levels of nutrients.

Therefore, it would be of interest to have a low-cost, nutritionally complete food that is highly concentrated in proteins mainly of plant origin, that would present a texture suitable for the type of food desired and that could be used as substitutes for animal protein-based food products.

The present inventors have discovered that a nutrient-rich food comprising proteins mainly of plant origin that had been treated with transglutaminase would respond to these requirements.

Food

This is why an object of the present invention relates to a food comprising proteins mainly of plant origin obtainable by a method comprising the steps consisting of:
(i) 15 selecting a natural source of plant proteins including nutrients;
(ii) extracting vegetable juice from the natural source of plant proteins, said vegetable juice comprising almost all or all of the nutrients contained in the natural source of plant proteins; and
(iii) treating said vegetable juice from step (ii) with transglutaminase,
   Said food also necessarily comprising a food ingredient of non-animal origin when the natural source of plant proteins is made exclusively of soya.

According to a particular embodiment, when the source of plant proteins is not made exclusively of soya, then the food can also include a food ingredient of non-animal origin.

According to the invention, “food” is understood to refer to a finished food that is nutritionally rich and ready to be consumed or cooked.

According to an embodiment, the food is chosen from the group consisting of foods of the cheese, sauce, cream dessert, juice, spread, patty, cake mix and pasta type and from cheese substitutes with or without maturing of the fondue, soft cheese, firm cheese or hard cheese type.

According to the invention, “mainly of plant origin” means that the proteins of plant origin contained in the food represent more than 50%, even more than 70%, preferably more than 90%, and still more preferably more than 95% by weight of the total weight of proteins contained in the food.

According to a particular embodiment, the food comprises proteins only of plant origin.

According to a particular embodiment, the food does not contain any component of animal origin.

According to the invention, “natural source of plant proteins” is understood to refer to at least one natural source of proteins chosen from among oil-rich, oil-protein-rich or protein-rich sources, cereal grains, leguminous plants, seeds and/or leaves from timber and non-timber forest products and mixtures thereof.

According to a particular embodiment, the source of natural proteins is chosen from among leaves, fruits and tree bark of the Fabaceae, Bombacaceae or Gnetaceae family.

According to another particular embodiment, the source of natural proteins is chosen from among oilseed plants and Fabaceae leguminous plants.

According to an embodiment, the natural source of plant proteins is chosen from among peanut, soya, cowpea, bean, pea, chickpea, lentil, sesame, quinoa, fenugreek, sorghum, timothy grass, millet, rice, fonio, maize, locust bean, moringa and mixtures thereof.

According to a particular embodiment, the natural source of plant proteins mainly consists of a combination of peanut and soya; Peanut and locust bean, soya and locust bean or peanut and moringa.

Advantageously, the natural source of plant proteins has not undergone any treatment such as, for example, peeling, pitting or seeding.

Therefore, by way of example, if the natural source of plant proteins is a seed, then it comprises its protective integument. If the natural source of plant proteins is a leaf, then it comprises the cane and nerves.

However, in the event where the natural source of plant proteins is not soya, said natural source of plant proteins may have undergone treatments such as peeling, pitting or seeding.

“Nutrient” is understood to refer to lipids, carbohydrates, mineral salts and vitamins.

“Almost all of the nutrients contained in the natural source of plant proteins” refers to more than 75%, preferably more than 85% and advantageously more than 95% of the nutrients contained in the natural source of plant proteins.

Therefore, according to the invention, the vegetable juice obtained after extraction and after treatment with transglutaminase not only comprises proteins but also comprises many nutrients such as lipids, carbohydrates, mineral salts, vitamins and mixtures thereof.

According to the invention, “vegetable juice” refers to a juice mainly free of insoluble residues (also known as fiber or Okara in the case of soya). “Mainly free of insoluble residues” refers to a vegetable juice comprising less than 20% by weight, preferably less than 10% by weight and still more preferably less than 0.5% by weight of insoluble residues in relation to the total weight of the vegetable juice.

According to the invention, transglutaminase is deactivated in the food prepared for consumption.

According to the invention, “ingredient of non-animal origin” refers to an ingredient that adds flavor to the food and/or contributes nutrients to the food.

According to a particular embodiment, the ingredient of non-animal origin is organic.

Therefore, according to an embodiment, the food ingredient of non-animal origin is chosen from oil, sugar, salt, pepper, starch, sweeteners, flavors, flavor enhancers, aromatics, preservatives such as nisin, lactic acid, malic acid and organic acids in general, spices such as ginger and sumbala, algae such as spirulina, flowers and fruits such as hibiscus, strawberry and tomato and mixtures thereof.

According to another embodiment, the food according to the invention comprises vitamins such as vitamins A, E, D and minerals such as calcium, phosphorus and potassium necessary for a balanced diet, that are added to those initially present in the vegetable juice (before and after treatment with transglutaminase) from which the food according to the invention is obtained.

According to an embodiment, the food of the invention comprises at least one texturizing agent such as carob gum, xanthan gum, guar gum, carboxymethyl cellulose, native or modified starches and mixtures thereof.

The inventors have demonstrated that the addition of a protease with the transglutaminase enables the use of texturizing agents to be reduced or even eliminated.

The addition of a protease also enables the flavor of the food, its physical stability and texture to be improved.

Therefore, according to a particular embodiment, the food also comprises a protease.

According to a particular embodiment, the protease is chosen from among endoproteases, exoproteases and mixtures thereof.

According to a particular embodiment, the food of the invention does not comprise texturizing agents when only one protease is added with the transglutaminase.

According to a particular embodiment, the protease is alkaline subtilisin (sold by the name of alcalase®).

According to the invention, when the natural source of plant proteins is made exclusively of soya, the food of the invention also comprises an ingredient of non-animal origin.

According to an embodiment, the food of the invention also comprises an ingredient of non-animal origin regardless of the natural source of plant proteins.

Through experimental data, the inventors have demonstrated that the necessary quantity of dry concentrated vegetable juice extract to be used for a food according to the invention would be significantly less than that required for a food not having been treated with transglutaminase to obtain a finished product presenting a similar texture.

Food Preparation

Therefore another object of the invention relates to a food preparation whose dehydration rate is controlled, and can be a pulverulent composition obtained by controlled dehydration of the food of the invention comprising proteins of plant origin and at least one ingredient of non-animal origin.

Therefore, according to an embodiment, the food ingredient of non-animal origin, preferably organic, is chosen from oil, sugar, salt, pepper, starch, sweeteners, flavors, flavor enhancers, aromatics, preservatives such as nisin, lactic acid, malic acid and organic acids in general, spices such as ginger and sumbala, algae such as spirulina, flowers and fruits such as hibiscus, strawberry and tomato and mixtures thereof.

This food preparation presents the advantage of being able to be transported and preserved more easily, especially when it is in pulverulent form. It can then enable, by rehydration, a food that is ready to consume or ready to cook or be used as a cooking aid to be reconstituted.

According to the invention, the pulverulent composition is present in the form of powder or granules that can present different particle sizes and can be obtained by various methods such as freeze drying, spray drying, roller drying or extrusion combined with a possible grinding. The drying methods cited can be combined or not combined with unitary granulation operations by simple compression or under wet conditions.

Production Method

Another object of the invention relates to a method of producing a food comprising proteins mainly of plant origin, said method comprising the steps consisting of:
(i) selecting a natural source of plant proteins including nutrients;
(ii) extracting vegetable juice from the natural source of plant proteins, said vegetable juice comprising almost all or all of the nutrients contained in the natural source of plant proteins;
(iii) concentrating said vegetable juice;
(iv) heating the mixture obtained in step (iii) to a temperature T1 of between 20 and 70° C. for a duration t1 of between 5 and 60 minutes;
(v) adding the transglutaminase to said concentrated vegetable juice;
(vi) possibly adding an acidifying agent to the mixture from step
(v) so that said mixture presents a pH of between 3.6 and 5.2;
(vii) heating the mixture obtained in step (vi) to a temperature T2 of between 80 and 140° C. for a duration t2 of between 2 and 60 minutes.

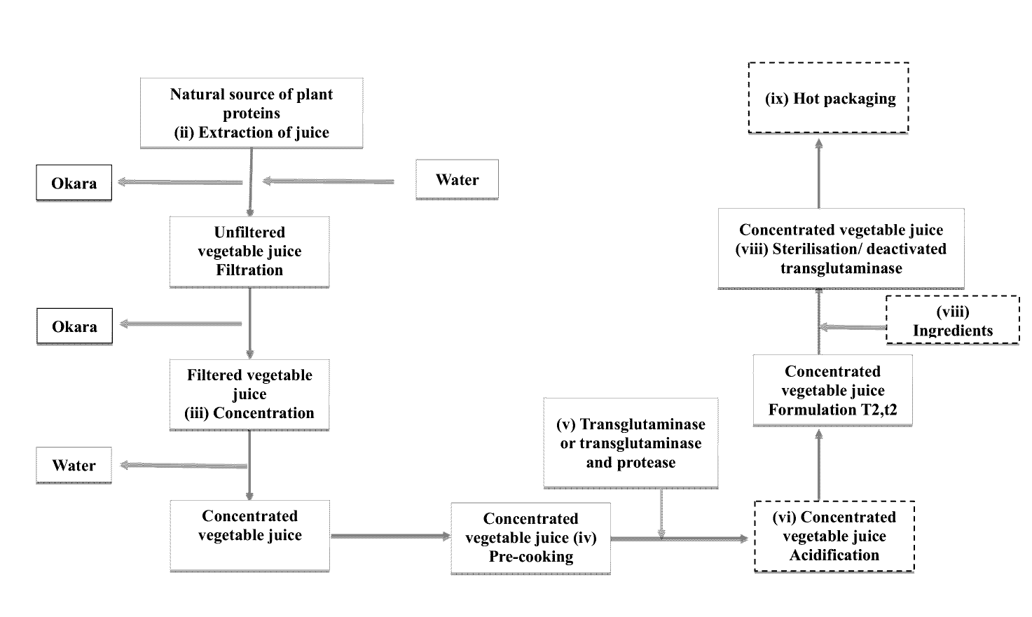

FIG. 1 is a diagram showing the different steps of the method, the optional steps being represented in boxes in dotted lines.

According to an embodiment, steps (iv) and (v) can be reversed or carried out simultaneously.

According to another embodiment, steps (iv), (v) and (vi) are carried out simultaneously or in a random order.

According to a particular embodiment, when steps (iv), (v) and (vi) are carried out simultaneously and as lactic ferments are added in step (v), then the thermal treatment of step (iv) is carried out at temperatures of between 30 and 45° C., preferentially between 35 and 40° C.

According to an embodiment, the mixture obtained in step (iii) is preferably heated to a temperature T1 of between 50 and 60° C. for a duration t1 of between 10 and 30 minutes to optimize the transglutaminase activation conditions.

According to an embodiment, the mixture obtained in step (vii) is homogenized at a pressure of between 50 and 700 bar.

According to an embodiment, the method of the invention comprises at least one additional step (viii) consisting of adding to the mixture obtained in step (vi) and/or in step (vii) at least one food ingredient of non-animal origin, preferably organic.

According to a particular embodiment, the food ingredient is chosen from oil, sugar, salt, pepper, starch, sweeteners, flavors, flavor enhancers, aromatics, preservatives such as nisin, lactic acid, malic acid and organic acids in general, texturizing agents, spices such as ginger and sumbala, algae such as spirulina, flowers and fruits such as hibiscus, strawberry and tomato, vitamins, minerals and mixtures thereof.

According to a particular embodiment, the food obtained at the end of the method of the invention presents a practically neutral pH.

For example, adding emulsifying salts enables the pH to be adjusted towards neutrality.

According to an embodiment that can be combined with the previous, the method of the invention comprises an additional step (ix) consisting of hot packaging the mixture obtained in step (vi) , (vii) or (viii).

Therefore, according to this embodiment, the hygienic quality of the finished product is preserved within its packaging.

Natural Source of Plant Proteins

According to the invention, “natural source of plant proteins” is understood to refer to at least one natural source of proteins chosen from among oil-rich, oil-protein-rich or protein-rich sources, cereal grains, leguminous plants, seeds and/or leaves from timber and non-timber forest products and mixtures thereof.

According to a particular embodiment, the natural source of proteins is chosen from among leaves, fruits and tree bark of the Fabaceae, Bombacaceae or Gnetaceae family.

According to another particular embodiment, the natural source of proteins is chosen from among oilseed plants and Fabaceae leguminous plants.

According to an embodiment, the natural source of plant proteins is chosen from among peanut, soya, cowpea, bean, pea, chickpea, lentil, sesame, quinoa, fenugreek, sorghum, timothy grass, millet, rice, fonio, maize, locust bean, moringa and mixtures thereof.

According to a particular embodiment, the natural source of plant proteins mainly consists of a combination of peanut and soya; peanut and locust bean, soya and locust bean or peanut and moringa.

Extraction

According to the invention, the vegetable juice is mainly free of insoluble residues (or fiber). “Mainly free of insoluble residues” refers to a vegetable juice comprising less than 20% by weight, preferably less than 10% by weight and still more preferably less than 0.5% by weight of insoluble residues in relation to the total weight of the vegetable juice.

Extraction of the vegetable juice can be carried out by various methods.

In general, extraction comprises the steps consisting of:
(i) supplying a natural source of plant proteins;
(ii) applying a mechanical stress possibly accompanied by thermal treatment to said natural source of plant proteins;
(iii) Extracting the insoluble residues to recover the vegetable juice.

According to an embodiment, the natural source of plant proteins is in the form of seeds or leaves.

Advantageously, the natural source of plant proteins is used in its entirety, i.e., without peeling, seeding, pitting, etc.

Therefore, according to this embodiment, the method of the invention enables a very nutrient-rich food to be obtained that does not require additional steps such as those mentioned (peeling, seeding, etc.), thereby making the method more simple and inexpensive.

However, in the event where the natural source of plant proteins is not soya, said natural source of plant proteins may have undergone treatments such as peeling, pitting or seeding.

According to an embodiment, step (ii) consists of a grinding or pressing step.

To minimize the quantity of residual insoluble residues, step (iii) may be carried out by any known means such as horizontal or vertical centrifugation, tangential microfiltration, natural decantation and frontal filtration.

According to a particular embodiment, vegetable juice extraction comprises the steps consisting of:
(a) supplying seeds and/or leaves from a natural source of plant protein and water in a grinder;
(b) grinding the mixture from step (a);
(c) heating the mixture obtained in step (b) to a temperature of between 70° C. and 80° C.;
(d) extracting the insoluble residues;
(e) pasteurizing at a temperature of between 90° C. and 115° C.;
(f) pre-cooling the vegetable juice thus obtained to a temperature corresponding to the fermentation temperature, typically between 10° C. and 40° C.

Step (c) of the stated extraction method has the effect of solubilizing proteins and destroying lipoxygenases.

Step (e) of the stated extraction method has the effect of stabilizing bacteria and destroying antitrypsin factors.

Advantageously, the seeds are ground and/or pressed with their integuments and the leaves are ground and/or pressed in their entirety.

Therefore, the vegetable juice obtained after extraction not only comprises proteins but also comprises the following nutrients: Lipids, carbohydrates, mineral salts, vitamins, water and mixtures thereof.

Concentration

According to the method of the invention, the vegetable juice extraction step is followed by a step of concentrating said vegetable juice.

According to an embodiment, the vegetable juice is concentrated to present a dry extract of between 15% and 30%, preferably between 20% and 25% and still more preferentially between 21% and 23%.

Depending on the dry extract content of the concentrated juice, the final content of the food can be adjusted.

Addition of Transglutaminase

According to the invention, transglutaminase is added in a sufficient quantity to create bonds between the plant protein amino acids.

Therefore, according to an embodiment, transglutaminase is added in a quantity of between 0.1% and 0.3%, preferably between 0.12 and 0.25% by weight in relation to the total weight of the concentrated vegetable juice.

According to an embodiment, at least one protease is added with the transglutaminase in step (v).

According to a particular embodiment, the protease is chosen from among endoproteases, exoproteases and mixtures thereof.

According to an embodiment, protease is added in a quantity of between 0.005% and 0.1%, preferably between 0.01 and 0.06% by weight in relation to the total weight of the concentrated vegetable juice.

Acidification

The acidification step enables the transglutaminase to be inactivated.

This step can be carried out by adding an acidifier chosen from the group consisting of an acid, a lactic ferment, GDL (glucono delta-lactone) and mixtures thereof to the mixture from step (v).

After acidification, the mixture preferably presents a pH of between 3.8 and 5.

According to an embodiment, the acid is chosen from the group consisting of citric acid, ascorbic acid, phosphoric acid, lactic acid, malic acid and mixtures thereof.

According to an embodiment, the acid and/or lactic ferments and/or GDL is/are added in a quantity from 1.2 to 1.8% by weight in relation to the total weight of the mixture.

Final Thermal Treatment Step

Step (vii) consisting of thermally treating the mixture obtained in the previous step to a temperature T2 of between 80 and 140° C. for a duration t2 of between 2 and 60 minutes enables the transglutaminase to be irreversibly deactivated and also enables the food obtained to be sterilized.

According to a particular embodiment, the mixture obtained in step (vi) is heated to a temperature of between 90 and 120° C. for a duration of between 2 and 60 minutes.

The method according to the invention enables various types of nutritionally-rich foods presenting different textures and viscosities such as, for example, sauces, cream desserts, juices, patties, cake mixes, spreads, cheese substitutes with or without maturing of the fondue, soft cheese, firm cheese or hard cheese type and pasta to be obtained.

Therefore, according to an embodiment, the food of the invention is a cheese substitute and comprises 5% to 20%, preferably 8% to 15% by weight of proteins in relation to the total weight of the food.

According to another embodiment, the food of the invention is a cream dessert and comprises 4% to 20%, preferably 7% to 15% by weight of proteins in relation to the total weight of the food.

According to still another embodiment, the food of the invention is a juice and comprises 2% to 5%, preferably 2.5% to 3.1% by weight of proteins in relation to the total weight of the food.

This is why the food of the invention or obtained with the method of the present invention is perfectly suitable for food that is not only rich in proteins but also rich in nutrients.

### EXAMPLES

In the following examples, percentages are expressed in weight percentages.

### Example 1

### Production of a Cheese-Type Product According to the Method of the Invention

Production of a cheese-type product according to the method of the invention comprises the following steps:
Supplying soya beans (with integuments),
Extracting soya juice by solid-liquid separation comprising the steps of centrifugation, pressing and filtration by adjusting or not adjusting the fat content;
   Concentrating the soya juice; the soya juice presents a dry extract of between 21% and 23%,
Thermally treating the concentrated soya juice at 50° C. for 20 minutes,
Adding 0.10% transglutaminase to the soya juice followed by a thermal treatment at 50° C. for 10 minutes,
Adding 1.7% by weight of phosphoric acid to deactivate the transglutaminase until a pH of 4.5 is reached,
Heating the mixture to 70° C.,
Adding 15% refined palm oil, previously heated,
Heating the mixture to 90° C.,
Adding the following ingredients: salt, sugar, calcium salts (calcium propionate and calcium carbonate), emulsifying salts (potassium mono/diphosphate), modified starches, carob gum, flavors (cheddar and emmental), and nisin,
Heating the mixture to 121.1° C. for 140 seconds (sterilization),
Homogenizing the mixture to 300 bar,
Hot packaging.

A processed cheese analogue is thus obtained with a dry extract of between 41.5-42.5% and a pH of between 5.6-5.8, the final composition of which is given in the table below.

TABLE A

| Ingredients g/100 g | g/100 g |
|---|---|
| Concentrated soya juice | 76.055 |
| Transglutaminase | 0.095 |
| Acid | 1 |
| Palm oil (fat) | 14 |
| Salt | 0.8 |
| Sugar | 1.2 |
| Calcium salts | 1.2 |
| Calcium propionate | 0.3 |
| Emulsifying salts (potassium | 2.8 |
| mono/diphosphate) | |
| Modified starches | 1.5 |
| Carob gum (texturizing | 0.5 |
| agent) | |
| Flavor | 0.5 |
| Nisin | 0.05 |
| | 100 |

### Example 2

### Impact of Transglutaminase Treatment on the Quantity of Dry Extract Necessary

The compositions of various peanut-based cream desserts are presented below.

These cream desserts have been obtained by the method comprising the following steps:
Supplying peanuts (with integuments),
Extracting peanut juice by solid-liquid separation comprising the steps of centrifugation, pressing and filtration involving or not involving fat content standardization;
Concentrating the peanut juice, peanut juice presents a dry extract of 40%,
Thermally treating the concentrated peanut juice at 50° C. for 20 minutes,
Adding the following ingredients according to the type of composition desired: sugar, cocoa, caramel flavor, coconut, vanilla, starch-type texturizing agents,
Heating the mixture to 121.1° C. for 140 seconds (sterilization),
Homogenizing the mixture at a pressure of 300 bar,
Hot packaging.

The carbohydrate, lipid and protein content is compared to that present in cream desserts made from milk, sold under the brand “La Laitière.”

### Composition 1

TABLE 1

| | Quantity | Proteins | Lipids | Carbohydrates |
|---|---|---|---|---|
| | (g) | (g) | (g) | (g) |
| 40% concentrated | 1555 | 239 | 245 | 119 |
| peanut juice | | | | |
| Sugar | 300 | | | 300 |
| Defatted cocoa powder | 72 | 17 | 8 | 25 |
| Starch | 40 | | | 40 |
| | 1967 | 256 | 253 | 484 |

| | | | |
|---|---|---|---|
| composition in % | 13.01 | 12.8 | 24.6 |
| Composition in | 19.6 | 43.36 | 37 |
| Kcal % | | | |
| Dairy cream | 4.3 | 10.3 | 18.1 |
| Composition in | 9.4 | 50.85 | 39.7 |
| Kcal % | | | |

### Composition 2

TABLE 2

| | Quantity | Proteins | Lipids | Carbohydrates |
|---|---|---|---|---|
| | (g) | (g) | (g) | (g) |
| 40% concentrated | 1555 | 239 | 245 | 119 |
| peanut juice | | | | |
| Sugar | 300 | | | 300 |
| Caramel flavor | 25 | 0 | 0 | 25 |
| Starch | 40 | | | 40 |
| | 1920 | 239 | 245 | 484 |

| | | | |
|---|---|---|---|
| composition in % | 12.44 | 12.7 | 25.2 |
| Composition in | 18.7 | 43.15 | 38 |
| Kcal % | | | |
| Dairy cream | 4.3 | 10.3 | 18.1 |
| Composition in | 9.4 | 50.85 | 39.7 |
| Kcal % | | | |

### Composition 3

TABLE 3

| | Quantity | Proteins | Lipids | Carbohydrates |
|---|---|---|---|---|
| | (g) | (g) | (g) | (g) |
| 40% concentrated | 1555 | 239 | 245 | 119 |
| peanut juice | | | | |
| Sugar | 250 | | | 250 |
| coconut | 135 | 9 | 90 | 12 |
| Starch | 40 | | | 40 |
| | 1980 | 248 | 335 | 421 |

| | | | |
|---|---|---|---|
| composition in % | 12.52 | 16.91 | 21.26 |
| Composition in | 17.43 | 52.98 | 29.6 |
| Kcal % | | | |
| Dairy cream | 4.3 | 10.3 | 18.1 |
| Composition in | 9.4 | 50.85 | 39.7 |
| Kcal % | | | |

### Composition 4

TABLE 4

| | Quantity | Proteins | Lipids | Carbohydrates |
|---|---|---|---|---|
| | (g) | (g) | (g) | (g) |
| 40% concentrated | 777.5 | 119.4 | 122.53 | 59.7 |
| peanut juice | | | | |
| 16% skimmed | 777.5 | 31.1 | 6.22 | 10.5 |
| concentrated peanut | | | | |
| juice | | | | |
| Sugar | 250 | | | 300 |
| Cocoa | 72 | 17 | 8 | 25 |
| Starch | 40 | | | 40 |
| | 1917 | 150.05 | 128.75 | 435.2 |

| | | | |
|---|---|---|---|
| composition in % | 7.82 | 6.71 | 22.7 |
| Composition in | 17 | 33 | 50 |
| Kcal % | | | |
| Dairy cream | 4.3 | 10.3 | 18.1 |
| Composition in | 9.4 | 50.85 | 39.7 |
| Kcal % | | | |

Tables 1-4 show that the energy supply of a peanut-based cream dessert obtained with the method previously described is higher than that of “conventional” milk-based cream desserts. The organoleptic qualities are similar to those of milk-based creams.

However, in this method the peanut juice is concentrated to 40%.

Consequently, it has been demonstrated (results not presented) that by using the method of the invention (i.e., comprising an additional step of treating the concentrated peanut juice with transglutaminase), a peanut juice concentrated to only 20% is necessary to obtain similar results (identical energy supply and texture) to those obtained with a conventional method requiring a 40% concentrated peanut juice.

### Example 3

### Production of a Meat Substitute-Type Product According to the Method of the Invention

The production of a meat substitute-type product according to the method of the invention comprises the following steps:
Supplying soya beans (with integuments),
Extracting soya juice by solid-liquid separation comprising the steps of centrifugation, pressing and filtration by adjusting or not adjusting the fat content;
Concentrating the soya juice until it presents a dry extract of between 20 and 23%,
Reheating the concentrated soya juice to 40° C.,
Adding meat flavors or spices or crushed leaves,
Adding 0.15% transglutaminase,
Adding lactic ferments to acidify and coagulate the proteins,
Fermenting for 4 to 5 hours, final pH of between 4.7 and 5,
Draining,
Cutting into cubes, or chopping using a meat cleaver

A nutrient-rich meat substitute product is thus obtained that does not present a loss of texture even when used in liquid sauces.

The transglutaminase that is deactivated by the pH is destroyed during the final sterilization of the product or when the foods are fried or cooked.

### Example 4

### Impact of Adding a Protease with the Transglutaminase in the Final Product

A spread-type product was produced according to the method of the invention.

In a first experiment A, alcalase® (alkaline subtilisin) was used together with transglutaminase.

In a second experiment B, only transglutaminase was used.

The operating conditions of these two experiments (A and B) are summarized below:
Supplying soya beans (72% by weight) and peanuts (28% by weight) with integuments,
Extracting soya and peanut juice by solid-liquid separation comprising the steps of centrifugation, pressing and filtration by adjusting or not adjusting the fat content;
Concentrating the soya and peanut juice; the soya and peanut juice presents a dry extract of between 27% and 28%,
Thermally treating the concentrated soya and peanut juice at 50° C. for 20 minutes,
Adding enzymes:
Adding 0.15% transglutaminase and 0.03% alcalase to the soya and peanut juice followed by thermal treatment at 50° C. for 20 minutes for experiment A,
Adding 0.15% transglutaminase to the soya and peanut juice followed by thermal treatment at 50° C. for 20 minutes for experiment B,
Adding approximately 10% refined palm oil, previously heated,
Adding ingredients of non-animal origin (see table 5 below),
Heating the mixture to 90° C.,
Heating the mixture to 118° C. for 4 minutes (sterilization),
Cooling the mixture to 90° C.,
Adding cheese flavor.

Thus a spread with a dry extract of between 37.5 and 38% is obtained, the final compositions of which are given in table 5 below.

TABLE 5

| | experiment A | | experiment B | |
|---|---|---|---|---|
| | | Weight | | Weight |
| | Quantity | (kg/ | Quantity | (kg/ |
| Raw Materials | (%) | 015.00 kg) | (%) | 015.00 kg) |
| Seed juice | 85.73% | 12.859 | 83.79% | 12.569 |
| Palm oil | 9.84% | 1.476 | 10.11% | 1.516 |
| Alcalase ® | 0.03% | 0.0045 | 0.00% | 0.0000 |
| Transglutaminase | 0.15% | 0.023 | 0.15% | 0.023 |
| Modified starch | 0.000% | 0.000 | 1.200% | 0.180 |
| Sugar | 0.8% | 0.120 | 0.8% | 0.120 |
| Calcium carbonate | 1.2% | 0.180 | 1.2% | 0.180 |
| Salt | 1.0% | 0.150 | 1.0% | 0.150 |
| Carob gum | 0.0% | 0.000 | 0.5% | 0.075 |
| Flavors | 1.2% | 0.180 | 1.2% | 0.180 |
| Nisin | 0.05% | 0.008 | 0.05% | 0.008 |
| TOTAL | 100.00% | 15.000 | 100.00% | 15.000 |

As shown by the results from table 5, the presence of alcalase obviates the need to use texturizing agents such as starch or carob gum that are necessary when transglutaminase alone is used to obtain a final product with a similar dry extract (37.5% for experiment A and 38% for experiment B) and texture.

1. A food comprising proteins mainly of plant origin obtainable by a method comprising the steps consisting of:
(i) Selecting a natural source of plant proteins including nutrients;
(ii) Extracting vegetable juice from the natural source of plant proteins, said vegetable juice comprising almost all or all of the nutrients contained in the natural source of plant proteins; and
(iii) Treating said vegetable juice from step (ii) with transglutaminase,
wherein said food also comprises a food ingredient of non-animal origin when the natural source of plant proteins is made exclusively of soya.

2. The food according to claim 1, wherein the natural source of proteins is chosen from the group consisting of oil-rich, oil-protein-rich or protein-rich sources, cereal grains, seeds and leaves from timber and non-timber forest products and mixtures thereof.

3. The food according to claim 1, wherein the natural source of proteins is chosen from the group consisting of peanut, soya, cowpea, bean, pea, chickpea, lentil, sesame, quinoa, fenugreek, sorghum, timothy grass, millet, rice, fonio, maize, locust bean, moringa and mixtures thereof.

4. The food according to claim 1, wherein the food ingredient of non-animal origin is organic.

5. The food according to claim 4, wherein the food ingredient of non-animal origin is chosen from oil, sugar, salt, pepper, starch, sweeteners, flavors, flavor enhancers, aromatics, preservatives such as nisin, lactic acid, malic acid and organic acids in general, spices such as ginger and sumbala, algae such as spirulina, flowers and fruits such as hibiscus, strawberry and tomato and mixtures thereof.

6. The food according to claim 1, wherein the food also comprises a protease chosen from endoproteases, exoproteases and mixtures thereof.

7. The food according to claim 6, wherein the protease is alkaline subtilisin.

8. The food according to claim 1, wherein said food is chosen from the group consisting of foods of the cheese, sauce, cream dessert, juice, spread, patty, cake mix and pasta type.

9. A pulverulent composition comprising the food according to claim 1.

10. A method of producing a food comprising proteins mainly of plant origin, said method comprising the steps consisting of:
(i) selecting a natural source of plant proteins including nutrients;
(ii) extracting vegetable juice from the natural source of plant proteins, said vegetable juice comprising almost all or all of the nutrients contained in the natural source of plant proteins;
(iii) concentrating said vegetable juice;
(iv) heating the mixture obtained in step (iii) to a temperature T1 of between 20 and 70° C. for a duration t1 of between 5 and 60 minutes;
(v) adding the transglutaminase to said concentrated vegetable juice;
(vi) possibly adding an acidifying agent to the mixture from step
(v) so that said mixture presents a pH of between 3.6 and 5.2;
(vii) heating the mixture obtained in step (vi) to a temperature T2 of between 80 and 140° C. for a duration t2 of between 2 and 60 minutes.

11. The method according to claim 10, wherein the concentrated vegetable juice presents a dry extract of between 15% and 30%.

12. The method according to claim 10, wherein a protease is added with the transglutaminase during step (v).

13. The method according to claim 10, wherein the acidifier is chosen from the group consisting of an acid, a lactic ferment, GDL (glucono delta-lactone) and mixtures thereof.

14. The method according to claim 10, wherein the method comprises an additional step (viii) consisting of adding to the mixture obtained in step (vi) and/or in step (vii) at least one food ingredient of non-animal origin chosen from oil, sugar, salt, pepper, starch, sweeteners, flavors, flavor enhancers, aromatics, preservatives such as nisin, lactic acid, malic acid and organic acids in general, texturizing agents, spices such as ginger and sumbala, algae such as spirulina, flowers and fruits such as hibiscus, strawberry and tomato, vitamins, minerals and mixtures thereof.

15. The method according to claim 10, wherein transglutaminase is added in a quantity of between 0.1 and 0.3% by weight in relation to the total weight of the concentrated vegetable juice.
